(19) United States
(12) Patent Application Publication
(10) Pub. No.: US 2025/0326404 A1
(43) Pub. Date: Oct. 23, 2025

(54) Computer-Implemented Method and System for Search-Based Behavior Planning for an Ego Vehicle

(71) Applicant: Robert Bosch GmbH, Stuttgart (DE)

(72) Inventors: Faris Janjos, Stuttgart (DE); Juergen Mathes, Stuttgart-Moehringen (DE); Markus Mazzola, Tuebingen (DE); Martin Stoll, Renningen (DE); Michael Hanselmann, Korntal-Muenchingen (DE); Nicolas Moeser, Renningen (DE); Maxim Dolgov, Renningen (DE)

(21) Appl. No.: 19/098,617

(22) Filed: Apr. 2, 2025

(30) Foreign Application Priority Data
Apr. 17, 2024 (DE) 10 2024 203 550.5

(51) Int. Cl. B60W 60/00; B60W 50/00; G06N 20/20

(52) U.S. Cl. CPC B60W 60/0011; B60W 50/0097; G06N 20/20

(57) ABSTRACT

A computer-implemented method is for search-based behavior planning for an ego vehicle in a traffic scenario involving at least one further participant. A scenario representation of the traffic scenario is generated based on aggregated scenario-specific information in order to generate, using a deep learning based planning component, a tree structure including multiple sequences of scenario representations for N>1 consecutive planning time increments i, i∈{0, . . . , N}. At least one one-shot prediction is also generated for at least one possible development of the traffic scenario for M>1 consecutive prediction time increments in order to associate the individual sequences of the tree structure with at least one such one-shot prediction. The subsequent scenario representations are generated in individual planning time increments i, i∈{1, . . . , N}, each based on at least one such one-shot prediction.

This application claims priority under 35 U.S.C. § 119 to patent application no. DE 10 2024 203 550.5, filed on Apr. 17, 2024 in Germany, the disclosure of which is incorporated herein by reference in its entirety.

### BACKGROUND

The disclosure relates to a computer-implemented method for search-based behavior planning for an ego vehicle in a traffic scenario involving at least one further participant.

A scenario representation of the traffic scenario is first generated on the basis of aggregated scenario-specific information. Based on the scenario representation, using a Deep Learning (DL)-based planning component, a tree structure is then generated from multiple sequences of scenario representations for N>1 consecutive planning time increments i, i∈{0, . . . , N}, such that each subsequent scenario representation generated in a planning time increment i, i∈{1, . . . , N} refers back to and is caused by exactly one parent scenario representation generated in the previous planning time increment i-1. The individual sequences of the tree structure are evaluated in order to then determine a behavior planning for the ego vehicle based on at least one sequence of the tree structure.

Furthermore, the disclosure relates to a computer-implemented system for search-based behavior planning for an ego vehicle in a traffic scenario involving at least one further participant.

Such a system comprises at least one perception plane for aggregating scenario-specific information at a planning timepoint and a DL-based processing plane for generating a scenario representation of the traffic scenario based on the aggregated scenario-specific information. In addition, such a system comprises a DL-based planning component which is designed so as to generate, based on a scenario representation generated by the processing plane, a tree structure consisting of multiple sequences of scenario representations for N>1 consecutive planning time increments i, i∈{0, . . . , N}, such that each subsequent scenario representation generated in a planning time increment i, i∈{1, . . . , N} refers back to and is caused by exactly one parent scenario representation generated in the previous planning time increment i-1. The planning component is further designed so as to evaluate the individual sequences of the tree structure and determine behavior planning for the ego vehicle based on at least one sequence of the tree structure.

The starting point for behavior planning is always the state of the traffic scenario at a planning timepoint, and in particular the state of all participants in the traffic scenario at the planning timepoint. The state of the traffic scenario is described by scenario-specific information aggregated from different sources of information at the planning timepoint in time or even over a certain period of time before and up to the planning timepoint. The information sources can be in-vehicle sensors, such as LiDAR sensors, radar sensors and/or RGB cameras installed on the ego vehicle, or non-vehicle sensors, such as inertial sensors, LiDAR sensors, radar sensors, and/or RGB cameras installed in or on infrastructure elements or other traffic participants. Other possible sources of information include stored map information, along with traffic rules if applicable, as well as retrievable weather and road condition information, traffic situation information, etc. The information from the different sources of information is aggregated from a perception plane and typically pre-processed to context information.

As already mentioned, based on the aggregated scenario-specific information, a scenario representation of the traffic scenario is generated as an input for a DL-based planning component. The scenario representation can simply be a representation of the traffic scenario in a latent space. To that end, the scenario-specific information is mapped onto a set of latent features using a backbone network. This representation of the traffic scenario in latent space can also be used for further analyses of the traffic scenario, for example, object detection, in order to generate an environmental model from the traffic scenario. Such an environmental model also depicts a scenario representation that could act as an input to a DL-based planning component.

In order to be able to plan safe and comprehensible maneuvers, automated vehicles must anticipate how the current traffic scenario will develop. This is particularly important when there are still further participants, such as other vehicles, cyclists, and pedestrians, in the traffic scenario. Therefore, one tries to predict the future behavior of all participants in the traffic scenario, preferably in the form of trajectories. One of the key findings in automated driving (AD) research is that the two components, prediction and planning, should not be implemented separately from one another, but rather that the planning should be based on the prediction and vice versa.

One class of planning approaches that natively takes this linking of planning and prediction into account are search-based planning approaches, such as Monte Carlo Tree Search (MCTS). These methods often operate at the plane of the object-based representation of the traffic scenario with multiple objects, each characterized by their size and dynamic object state. They roll out into the future how the constellations of the objects will change. In these planning approaches, a search tree is iteratively constructed for N>1 subsequent planning time increments that represents possible developments of a traffic scenario in different sequences of N scenario representations. The branching of the tree structure results in a parent scenario representation due to the participants' different behavioral options, resulting in several different subsequent scenario representations. The parent scenario representations are also referred to as parent nodes of the tree structure, and the different subsequent scenario representations are referred to as child nodes. Typically, each child node generated in a planning time increment acts as a parent node for the subsequent planning time increment. Accordingly, uniformed rolling out into the future results in the space of possibilities becoming very large.

Because each child node is associated with exactly one parent node, the behavior of the considered participants is associated with the driving situation in the underlying parent node upon transitioning to the driving situation into a child node.

These search-based planning approaches are increasingly enriched with deep learning (DL) in order to be able to address challenging scenarios that are not manageable with classical model-based approaches—see DeepMind, “AlphaStar: Mastering the real-time strategy game StarCraft II”—or to be able to reduce the computing time of the search significantly—see Banzhaf et al., “Learning to Predict Ego-Vehicle Poses for Sampling-Based Nonholonomic Motion Planning”, 2019.

The challenge in the construction of the described search tree is to predict meaningful maneuvers for the participants of the traffic scenario and thus to only generate meaningful developments of a driving situation of the ego vehicle.

### SUMMARY

The measures according to the disclosure enable an efficient focusing of a search-based behavior planning on meaningful developments of the traffic scenario.

This is achieved according to the disclosure in that at least one one-shot prediction is generated for at least one possible development of the traffic scenario for M>1 consecutive prediction time increments, and the individual sequences of the tree structure are each associated with at least one such one-shot prediction, by generating the subsequent scenario representations in the individual planning time increments i, i∈{1, . . . , N}, each based on at least one such one-shot prediction.

The behavior planning system according to the disclosure comprises at least one predictor component configured so as to generate at least one one-shot prediction for at least one possible development of the traffic scenario for M>1 consecutive prediction time increments. Furthermore, the planning component is configured such that the individual sequences of the tree structure are each associated with at least one such one-shot prediction, by generating the subsequent scenario representations in the individual planning time increments i, i∈{1, . . . , N}, each based on at least one such one-shot prediction.

In the context of the disclosure, generally different formats of one-shot predictions can be used for a possible development of the traffic scenario. Essential for all of these formats is that the prediction horizon is greater than 1, i.e. that the one-shot prediction not only predicts a single time increment, but also predicts the evolution of the traffic scenario for a larger time period spanning multiple time increments.

Preferably, the planning time increments and the prediction time increments are the same in length and timing. However, this is not absolutely necessary for implementing the disclosure.

At this point, it should be noted that the inference timing can also differ from the timing of the planning and/or prediction. For example, the inference can be performed every 100 ms, while the planning provides a 1-second timing between the nodes of the search tree.

One-shot predictions in the form of trajectories are often used for individual participants in the traffic scenario. Each trajectory comprises a participant's position data at M consecutive timepoints. Such trajectory data can additionally include participant state data for the M timepoints, such as speed, acceleration, and/or orientation data. This form of one-shot prediction is appropriate when using a global coordinate system for planning.

If a grid-based representation of the traffic scenario is used for planning, it can be advantageous to present the one-shot predictions for a possible development of the traffic scenario in the form of occupancy data of grid cells in the scenario representation.

At this point, one-shot predictions in the form of intentions of the traffic scenario participants should also be mentioned.

To simplify the description and illustrate the subject-matter of the disclosure, it is always assumed in the following that the one-shot predictions are given in the form of trajectory data for the individual participants in the traffic scenario and that the planning time increments and the prediction time increments are of equal length and have the same timing.

The core idea of the disclosure is to already consider one-shot predictions for possible developments in the traffic scenario when generating the search tree, in that the scenario representations of the individual sequences of the tree structure are each associated with at least one such one-shot prediction. The one-shot predictions can be interpreted herein as non-parametric maneuver modes to which the generated search tree is directed. The number of maneuver modes can be interpreted as a branching factor. In any case, the search tree no longer needs to be pruned, or at least to a lesser extent.

According to the disclosure, the DL-based planning component is configured so as to provide sampling distributions for generating child nodes and/or subsequent scenario representations, which are not only associated with the underlying parent node or the parent scenario representation, but also with one-shot predictions for the development of the traffic scenario.

According to the disclosure, it has been found that the construction of the search tree can thereby be focused on realistic developments in the traffic scenario. Because the need for pruning is thus eliminated or at least significantly reduced, the planning method according to the disclosure is also a possibility for real-time applications.

It proves advantageous in this context that already-existing, extremely powerful one-shot predictors can also be used as part of the planning process according to the disclosure.

In addition, model-based approaches, such as Responsibility-Sensitive Safety (RSS), see Shalev-Schwartz et al., “On a Formal Model of Safe and Scalable Self-driving Cars”, 2017, for checking collision avoidance and compliance with the traffic regulations for DL-generated maneuvers can be applied, because these methods are condition-based and are anticipated in the nodes of the search tree according to the disclosure. In this way, the AI component can be additionally secured in the planner, which is extremely relevant for an approval of an AD system.

In principle, different methods for generating one-shot predictions can be employed as part of the planning method according to the disclosure. Classic prediction methods typically use simple kinematic models for the individual participants of the traffic scenario. Because this prediction method can only model interactions between the participants in a causal manner, in recent years, the use of machine learning, in particular deep learning (DL), has been established as the de facto standard for prediction. Hybrid methods are often also used, which, in addition to DL, also use defined rules for prediction.

In a preferred embodiment of the disclosure, at least one initial one-shot prediction for M>1 consecutive prediction time increments is generated at the planning timepoint based on the scenario representation. These initial one-shot predictions are then used, at least in the first planning time increment i=1, by the planning component in order to generate subsequent scenario representations.

In a variant of the planning method according to the disclosure, referred to as a “single shot”, initial one-shot predictions are generated based on the scenario representation, whose prediction horizon M is at least as large as the planning horizon N, i.e. M≥N. Namely, in the single-shot variant, the generation of the individual subsequent scenario representations of the tree structure is always based on the initial one-shot predictions in all planning time increments i, i E {1, . . . , N}.

An advantage of this variant is that the computing time scales linearly with the number of the predicted modes, because, after the first branching, i.e. after the first planning time increment i=1, an initial one-shot prediction is recorded as a one-shot reference trajectory for each participant in the traffic scenario.

In one embodiment of the disclosure, alternatively or in addition to the initial one-shot predictions for each parent scenario representation of the individual planning time increments i, i E {1, . . . , N}, respectively, current one-shot predictions for M>1 consecutive prediction time increments are generated. In this way, the prediction is progressively adjusted to the planning in order to accommodate the fact that the participants' behavior in the individual nodes of the search tree or in the planning time increments i, i∈{2, . . . , N} mostly deviates from the initial one-shot predictions.

Generally, there are different ways to generate current one-shot predictions for search tree scenario representations. For example, classical rule-based prediction methods, or also DL-based prediction methods, can be used in order to generate one-shot predictions for the individual traffic scenario participants based on the state information of the individual participants in the particular scenario representation and based on map information about the road topology.

The current one-shot predictions are advantageously used in a variant of the planning method according to the disclosure, referred to as an “iterative”. In this variant, the generation of the subsequent scenario representations in the individual planning time increments i, i∈{1, . . . , N} are based on current one-shot predictions.

In this embodiment, the one-shot predictions are regenerated in each planning time increment i, i∈{1, . . . , N} and used as the basis for the generation of the sampling distribution for the respective subsequent scenario representations. Although this embodiment requires a higher computing time, it can generate the exactly fitting one-shot prediction for the particular driving situation in a tree node.

At this point, it should be mentioned that the iterative prediction can also be carried out, for example, for training purposes only during the training phase of the system according to the disclosure, namely in addition to the “single shot” variant. In this case, only the “single shot” variant would still be used for the inference in operation.

In a particularly advantageous embodiment of the planning method according to the disclosure, a value describing the probability of occurrence of the corresponding development of the traffic scenario is predicted together with the at least one one-shot prediction. In this case, the predicted probabilities of occurrence are taken into account when selecting the one-shot predictions for generating the sequences of scenario representations, which contributes significantly to the focus of planning on realistic developments of the traffic scenario.

In an advantageous further development of the disclosure, a predetermined classification of the driving style of the further participants of the traffic scenario is also taken into account in the search tree-based planning for the ego vehicle, because different driving styles of the further participants, e.g. aggressively, too cautiously, etc., affect the maneuvers of the ego vehicle.

The classification of the driving styles of the further participants results in a more specific distribution for the prediction for the individual participants, or a consistent coverage of different driving styles. In addition, the number of branches of the search tree can be reduced when the different driving styles of the subscribers are considered during the generation of the search tree.

Advantageously, the driving style of the individual participants is explicitly considered in the construction of the search tree. One way to do this is to determine a single driving style for each road participant—for example, using a DL-based classifier or decision-making rules—and then consider that driving style when building the tree and/or in open loop prediction. Alternatively, a distribution can be determined across the driving styles, and, for each type, a search tree can be built with corresponding open loop prediction for each participant. The probability of the behaviors resulting from the different driving styles can be incorporated into the costs, and thresholds can be put in place to exclude very unlikely behaviors.

### BRIEF DESCRIPTION OF THE DRAWINGS

Exemplary embodiments and advantageous further developments of the disclosure are explained in more detail in the following in conjunction with the figures.

FIG. 1 illustrates a search tree-based behavior or maneuver planning for an ego vehicle according to the prior art and shows a tree of possible developments of a current traffic scenario or driving situation of the ego vehicle that is constructed and evaluated in the course of the planning;

FIG. 2a illustrates a variant of the method according to the disclosure for search-based behavior planning for an ego vehicle, wherein the result of a multimodal open-loop prediction is in the form of four different developments of a current traffic scenario;

FIG. 2b illustrates a variant of the method according to the disclosure for search-based behavior planning for an ego vehicle, wherein the influence of the method according to the disclosure is on the iterative construction of a search tree;

FIG. 3 shows a block diagram for the single-shot variant of the planning method according to the disclosure; and

FIG. 4 shows a block diagram for the iterative variant of the planning method according to the disclosure.

### DETAILED DESCRIPTION

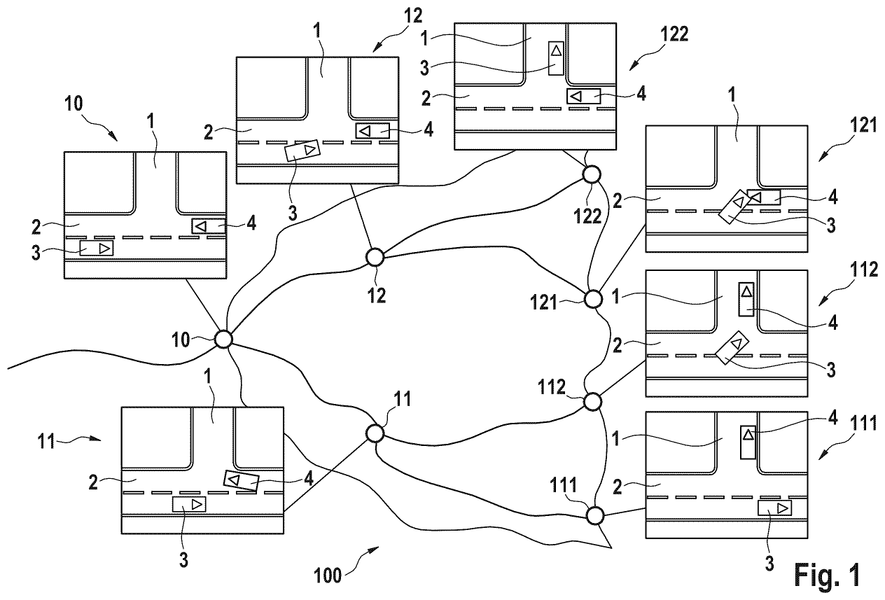

Search-based planners for AD iteratively build a tree of possible developments of a traffic scenario or driving situation, as shown in FIG. 1. In so doing, the participants of the scenario will be selected based on the driving situation in the current node, with which the developments into the next nodes are generated. The selected maneuvers are then used in order to generate the developments in the next nodes. Accordingly, the distributions from which the maneuvers are selected or sampled are associated with the past driving situations. These distributions are also hereinafter referred to as sampling distributions.

The starting point of the search tree structure 100 shown in FIG. 1 is a current traffic situation 10 in the region where a single-lane road 1 merges onto a two-lane road 2. The single-lane road 1 merges from the north into the two-lane road 2, which is oriented in an east-west direction. On the two-lane road 2, there is an ego vehicle 3 and a further vehicle 4. The ego vehicle 3 approaches the intersection from the west while the other vehicle 4 approaches the intersection from the east.

For maneuver planning for the ego vehicle 3 in the current traffic situation 10, scenario-specific information was first aggregated in order to generate a scenario representation of the current traffic scenario 10 as the input for a DL-based planning component. The shown tree structure 100 was then iteratively generated in N=2 planning time increments i where i∈{0, 1, 2}. The current traffic situation 10 is represented here by the initial node 10 of the tree structure 100 in the planning time increment i=0. A branching factor of 2 was used as the basis for rolling out the present tree structure 100. That is to say, from each node of a planning time increment i, two child nodes emerge, describing different behavioral options of the involved participants 3 and 4 in the form of scenario representations. The selection of the different behavioral options is made here based on heuristics, by contrast to the planning method according to the disclosure. The child nodes 11 and 12 of the first planning time increment i=1 describe the scenario representations:
11 “The ego vehicle 3 enters the intersection while driving straight on the two-lane road 2, while the further vehicle 4 starts to turn right into the one-lane road 1” and
12 “The ego vehicle 3 starts to turn left onto the one-lane road 1, while the further vehicle 4 continues straight on the two-lane road 2 and approaches the intersection from the east.”

The child nodes 111, 112, 121, 122 of the second planning time increment i=2 describe the scenario representations: 111 “The further vehicle 4 has turned to the right and travels north on the single-lane road 1. The ego vehicle 3 has passed the intersection and continues straight ahead on the two-lane road 2.” 112 “The further vehicle 4 has turned to the right and travels north on the single-lane road 1, while the ego vehicle 3 turns left onto the single-lane road 1.” 121 “The ego vehicle turns to the left onto the single-lane road 1, colliding with the further vehicle 4, which enters the intersection from the east.” 122 “The ego vehicle 3 has turned to the left and travels north on the single-lane road 1, while the further vehicle 4 has reached the intersection.”

Accordingly, the tree structure 100 comprises multiple sequences of scenario representations for the subsequent planning time increments i, i∈{0, 1, 2}, wherein each subsequent scenario representation generated in a planning time increment i, i∈{1, 2} refers back to and is caused by exactly one parent scenario representation generated in the previous planning time increment i-1. In the present case, the tree structure 100 comprises the following sequences of scenario representations:

| | |
|---|---|
| a) | 10, 11, 111 |
| b) | 10, 11, 112 |
| c) | 10, 12, 121 |
| d) | 10, 12, 122 |

The DL-based planning component evaluates the individual sequences of the tree structure 100 in order to then determine a behavioral planning or maneuver planning for the ego vehicle 3 based on at least one sequence of the tree structure 100.

As mentioned previously, the planning method discussed above uses heuristics in order to determine the sampling distributions of the scenario representations when the tree structure is rolled out. These sampling distributions are essentially limited only to the respective parent nodes. By contrast, according to the disclosure, one-shot predictions are used in order to generate sampling distributions that are not only associated with the respective parent nodes, but additionally also with one-shot predictions for multi-modal developments of the traffic scenario.

These depict the uncertainty about the future development of the traffic scenario both via the modes (intention uncertainty) and the uncertainty of movement (motion uncertainty). The non-parametric representation of predicted trajectories is thus significantly more powerful than pure intentions.

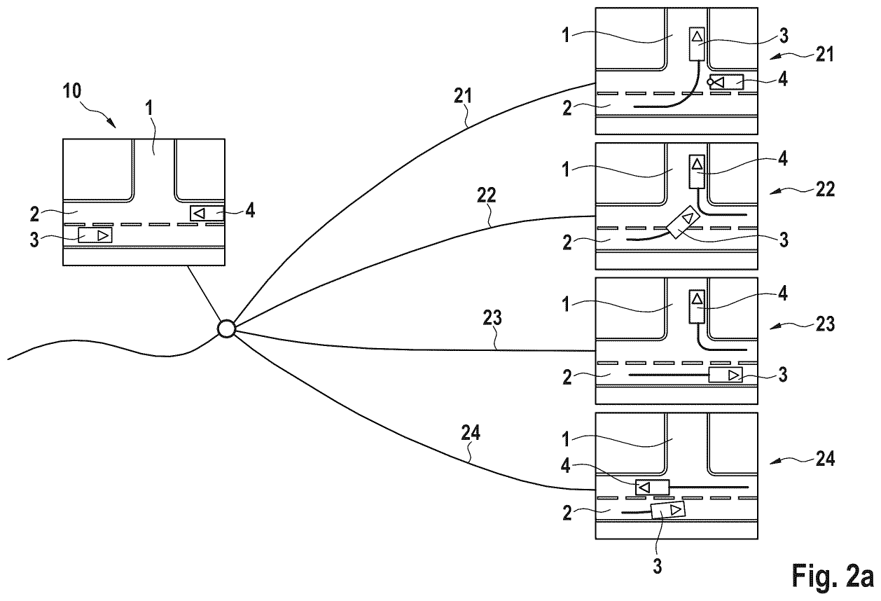

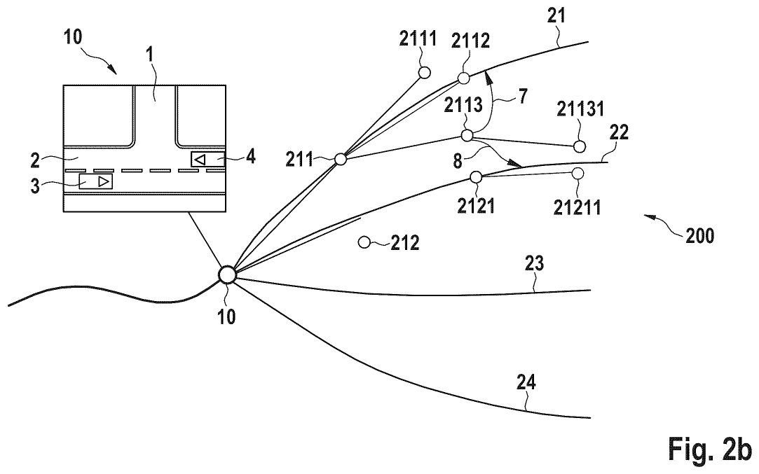

This is explained in more detail below with the help of FIGS. 2a and 2b.

FIG. 2a shows the result of a multimodal open-loop prediction in the form of four different developments of the current traffic scenario 10 depicted in FIG. 1. The representation of individual prediction steps has been omitted here for reasons of clarity. The four different predicted developments 21-24 can be described as follows:
21 “The further vehicle 4 stops in front of the intersection, while the ego vehicle 3 turns left onto the single-lane road 1.”
22 “The further vehicle 4 has turned to the right and travels north on the single-lane road 1. The ego vehicle 3 slows, in order to then turn left onto the single-lane road 1.”
23 “The further vehicle 4 is turned to the right and travels north on the single-lane road 1. The ego vehicle 3 has passed the intersection and continues straight ahead on the two-lane road 2.”
24 “The further vehicle 4 has passed the intersection and continues straight ahead west on the two-lane road 2. The ego vehicle 3 stops in order to turn left behind the further vehicle 4 onto the single-lane road 1.”

The predicted development 23 is not considered in the subsequent maneuver planning, because the route of the ego vehicle 3 proposed here does not match the route desired by the ego vehicle 3, according to which the ego vehicle wishes to turn left into the single-lane road 1.

FIG. 2b illustrates how the initial one-shot predictions 21 to 24 shown in FIG. 2a are considered as part of the planning method according to the disclosure when rolling out a tree structure 200.

Starting from the current traffic situation, node 10 in the planning time increment i=0, child nodes are generated in the first planning time increment i=1 for those one-shot predictions that are compatible with the route desired by the ego vehicle 3. In the present case, these are the one-shot predictions 21, 22, and 24, which provide for a left turn of the ego vehicle 3.

For the sake of clarity, only the child nodes 211 and 212 are shown in FIG. 2b, which correspond to the one-shot predictions 21 and 22. The scenario representations of these child nodes can be described as follows:
211 “The ego vehicle 3 only slightly reduces its speed and prepares to turn.”

In this case, the planning according to the one-shot prediction 21 assumes that the other vehicle 4 will stop before the intersection.
212 “The ego vehicle brakes sharply and prepares to turn left onto the single-lane road 1.”

In this case, the planning according to one-shot prediction 22 assumes that the other vehicle 4 will turn right in order to travel north on the single-lane road 1.

The child nodes 211 and 212 generated in the first planning time increment i=1 form parent nodes for the following planning time increment i=2. In this planning time increment i=2, a number of child nodes specified as the branching factor are generated for each parent node. In the exemplary embodiment described here, the branching factor is three. For the sake of clarity, only the three child nodes 2111, 2112, and 2113 of parent node 211 are shown in FIG. 2b, as well as one child node 2121 of the parent node 212. The scenario representations of these child nodes can be described as follows:
2111 “The ego vehicle 3 accelerates in order to turn left even faster in front of the further vehicle 4.”
2112 “The ego vehicle 3 continues its journey according to the behavior in parent node 211—no change in behavior.”
2113 “The ego vehicle 3 slows down sharply because the further vehicle 4 has the right of way.”
2121 “The ego vehicle comes to a standstill because the further vehicle 4 has the right of way.”

For each child node generated in the planning time increment i=2 or for the corresponding scenario representations, so-called association scores are determined, each describing the proximity of a node to the initial one-shot predictions. This is illustrated in FIG. 2b, as an example for node 2113. The corresponding scenario representation 2113 provides that the ego vehicle 3 slows down sharply because the further vehicle 4 has the right of way.” The association score—arrow 7—for the initial one-shot prediction 21, according to which the further vehicle 4 stops in front of the intersection, is significantly lower than the association score—arrow 8—for the initial one-shot prediction 22, according to which the further vehicle 4 turns to the right.

Accordingly, the sequence of scenario representations 10, 211, 2113 in the following planning time increment i=3 is preferably continued based on the initial one-shot prediction 21, which is indicated in FIG. 2b by the child node 21131. The corresponding scenario representation can be described as follows:
21131 “The ego vehicle 3 turns left onto the single-lane road 1 after the further vehicle 4 has turned right onto the single-lane road 1.”

In the exemplary embodiment described herein, the sequence of scenario representations 10, 211, 2113, 21131 was thus initially caused by the initial one-shot prediction 21. However, the progressing planning was then based on the initial one-shot prediction 22, because a higher association score and thus a higher probability of occurrence was attributed to the corresponding development of the traffic scenario.

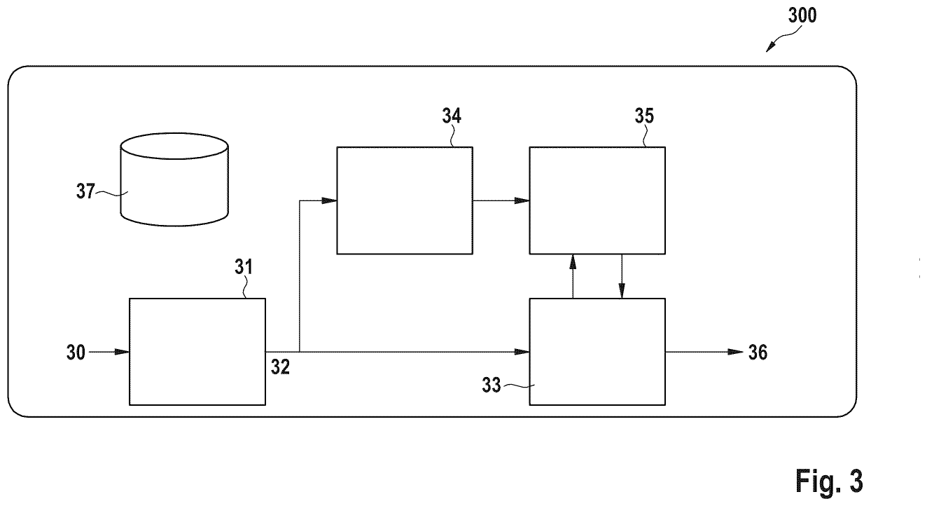

FIG. 3 illustrates the functionality of a system 300 according to the disclosure for search-based behavior planning for an ego vehicle in a given traffic scenario involving at least one further participant. The system 300 is configured for the single-shot variant of the planning method according to the disclosure described above. As already mentioned, in this process variant, initial one-shot predictions are only generated in the initial node, i.e. at the start of planning, for different development opportunities of the parent traffic scenario. These initial one-shot predictions will then be used as input during planning for the generation of the respective sampling distribution when rolling out the search tree.

The system 300 according to the disclosure comprises a perception plane for aggregating scenario-specific information 30 of a traffic scenario at a planning timepoint. The perception plane, not shown in detail herein, comprises or at least has access to different sources of information. This can be, for example, on-board and/or off-board sensors and/or stored map information, as well as retrievable weather and road condition information, traffic condition information, etc. Furthermore, the system 300 depicted herein comprises a data store 37 for information that can be utilized for rule-based planning and provided off-line, such as map information, traffic rules, etc.

The aggregated scenario-specific information 30 is fed to a DL-based processing plane 31 in order to generate a scenario representation of the traffic scenario. In the exemplary embodiment described herein, the DL-based processing plane 31 is a backbone network that maps the scenario-specific information 30 onto a set of latent features, i.e. a representation 32 of the traffic scenario in a latent space. The latent representation 32 of the traffic scenario is fed to a DL-based planning component 33 and to a predictor component 34.

The predictor component 34 generates, based on the latent representation 32, initial one-shot predictions for possible development of the traffic scenario for M>1 consecutive prediction time increments. In the present case of the single-shot variant, the prediction horizon M is at least exactly as large as the planning horizon N, i.e. M≥N.

The initial one-shot predictions generated in this way are used as an input variable for a module 35, which iteratively generates sampling distributions for the possible developments of the traffic scenario, i.e. the behavior of the individual participants in the scenario, in order to infer maneuvers from them, with which the scenario can be further moved into the next nodes of the search tree.

The planning component 33 generates, based on the latent representation 32, a tree structure consisting of multiple sequences of scenario representations for N>1 consecutive planning time increments i, i∈{0, . . . , N}. In doing so, it associates the individual sequences of the tree structure in each planning time increment i with at least one maneuver of the sampling distribution. Iterative generation of sampling distributions based on the initial one-shot predictions is illustrated by the arrows between the planning component 33 and the sampling distribution module 35.

Thus, in this embodiment, only at the time of the root node are initial one-shot predictions generated. These are then used in the generation of the sampling distributions in the individual planning time increments i, i∈{0, . . . , N}. It must be taken into account here that the behavior of the participants in the nodes of the search tree deviates from these initial one-shot predictions. To this end, the one-shot predictions could be treated similar to a context map (street topology). In the case of a grid-based representation of the traffic scenario, the one-shot predictions could be transformed to the current pose of the respective agent. In the case of a graph-based representation of the traffic scenario, the features of the one-shot predictions could be converted to the respective coordinate frame. Alternatively, a global coordinate system can be used in order to work around this issue—see, for example, Chen et al., “ScePT: Scene-consistent, Policy-based Trajectory Predictions for Planning”.

The planning component 33 evaluates the individual sequences of the tree structure in order to determine, on this basis, at least one sequence of the tree structure for determining a behavioral or maneuver planning 36 for the ego vehicle.

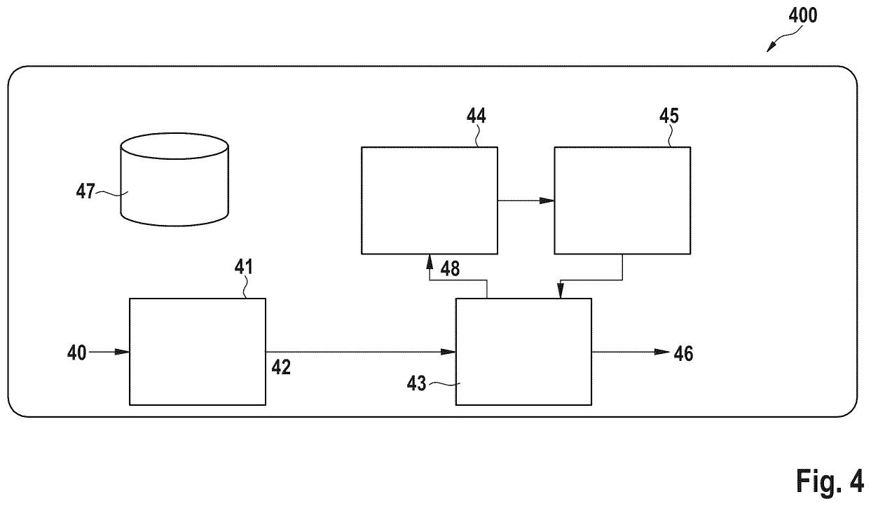

By contrast to the system 300 shown in FIG. 3, the system 400 shown in FIG. 4 is configured for the iterative variant of the planning method according to the disclosure. In this variant, in each planning time increment, current one-shot predictions for the respective scenario representations are regenerated and used as a basis for the generation of sampling distributions.

Like the system 300, the system 400 also comprises a perception plane not shown herein for aggregating scenario-specific information 40 of a traffic scenario, a data store 47 for off-line available information on the traffic scenario, and a DL-based processing plane 41 in the form of a backbone network for generating a latent representation 42 of the traffic scenario. Here, too, the latent representation 42 is fed to a DL-based planning component 43, which gradually rolls out a search tree with scenario representations for the possible developments of the traffic scenario in N>1 planning time increments i, i∈{0, . . . , N}.

By contrast to the variant shown in FIG. 3, the scenario representations 48 generated in the individual planning time increments i are fed here to a predictor component 44, which then generates current one-shot predictions based on the respective scenario representation 48 for further development of this scenario representation 48.

A sampling distribution module 45 generates a current sampling distribution in each planning time increment i based on the respective current one-shot predictions, so that, when generating the subsequent scenario representations, the corresponding current sampling distribution is always taken into account.

As in the case of the system 300, the planning component 43 also ultimately evaluates the individual sequences of the tree structure in order to determine, on this basis, at least one sequence of the tree structure for determining a behavioral or maneuver planning 46 for the ego vehicle.

It can be seen from FIG. 4 that the predictor component 44 can be provided with the latent representation 42 of the traffic scenario via the planning component 43, such that it can be incorporated into the respective current one-shot predictions. However, the predictor component 44 could also use prediction methods that do not require latent features from environmental modeling.

A further option is to generate latent features in the individual planning time increments, for example, from vector-like states of the individual participants and information about the road topology. A correspondingly trained GAN (Generative Adversarial Network) could be used for this purpose.

The latent features are predicted with a specific predictor based on the current configuration of the agents and the information about the road topology using a DL model. During training, this predictor for latent features of the environmental context can be trained on encoded context features in a self-supervised manner. Essentially, the context predictor would match the output of the context encoder that will be trained on future environmental information during training-see Janjos et al., “Self-Supervised Action-Space Prediction for Automated Driving”.

The network operates on a self-predicted world model. This means that the network generates its own world model for each prediction path in the form of latent features-see Hafner et al. “Mastering Atari with Discrete World Models”.

In both the single-shot embodiment 300 and the iterative embodiment 400, the predictor component 34 and 44, respectively, are advantageously configured so as to predict a value describing the probability of occurrence for the corresponding development of the traffic scenario for each generated one-shot prediction. Alternatively, an additional classifier component can also be provided, which would be connected between the predictor component 34 or 44 and the sampling distribution module 35 or 45, respectively. Many modern prediction methods learn a discrete distribution of probabilities for a range of predicted multimodal trajectories, which can be interpreted as the probability of each predicted trajectory. In practice, this distribution is learned from the predicted trajectories and latent features of the environmental context. In the context of the disclosure, such a classifier component could receive the output of the predictor component 34 or 44 as an input and provide the probabilities as a classifier output to the sampling distribution module 35 or 45, respectively.

Furthermore, the predictor component 34 or 44 can be configured so as to determine at least one driving style, or a distribution of driving styles, for the at least one additional participant, so that the planning component 33 or 43 can generate different tree structures for different driving styles of the participants.

Finally, it should be noted that the DL components connected in a system 300 or 400 can be trained cither individually or together, in other words end-to-end. In doing so, methods of teacher forcing can be used in order to have meaningful inputs for the downstream components at the start of training.

What is claimed is:

1. A computer-implemented method for search-based behavior planning for an ego vehicle in a traffic scenario involving at least one further participant, comprising:
generating a scenario representation of the traffic scenario based on aggregated scenario-specific information;
using, based on the scenario representation, a deep learning (“DL”) based planning component to generate a tree structure from multiple sequences of scenario representations for N>1 consecutive planning time increments i, i∈{0, . . . , N}, such that each subsequent scenario representation generated in a corresponding planning time increment i, i∈{1, . . . , N} refers back to and is caused by exactly one parent scenario representation generated in a previous planning time increment i-1;
generating at least one one-shot prediction for at least one possible development of the traffic scenario for M>1 consecutive prediction time increments, wherein individual sequences of the tree structure are each associated with at least one one-shot prediction; and
generating the subsequent scenario representations in the individual planning time increments i, i∈{1, . . . , N}, each based on at least one one-shot prediction.

2. The computer-implemented method according to claim 1, further comprising:
generating, based on the scenario representation, at least one initial one-shot prediction for M>1 consecutive prediction time increments.

3. The computer-implemented method according to claim 1, further comprising:
generating, based on the scenario representation, at least one initial one-shot prediction for M≥N consecutive prediction time increments,
wherein the generation of individual subsequent scenario representations in all planning time increments i, i∈{1, . . . , N} is based on the at least one initial one-shot prediction.

4. The computer-implemented method according to claim 1, further comprising:
generating, for each parent scenario representation of the individual planning time increments i, i∈{1, . . . , N}, in a rule-based and/or DL-based manner, at least one current one-shot prediction for M>1 consecutive prediction time increments.

5. The computer-implemented method according to claim 4, wherein the generation of the individual subsequent scenario representations is based on the at least one current one-shot prediction in at least one planning time increment i, i∈{1, . . . , N}.

6. The computer-implemented method according to claim 1, further comprising:
predicting, along with the at least one one-shot prediction, a value describing a probability of occurrence of the corresponding development of the traffic scenario,
wherein the predicted probabilities of occurrence are taken into account when selecting the one-shot predictions for generating the sequences of scenario representations.

7. The computer-implemented method according to claim 1, wherein, when predicting possible developments of the traffic scenario and/or when generating the tree structure, at least one driving style of the at least one further participant is taken into account.

8. A computer-implemented system for search-based behavior planning for an ego vehicle in a given traffic scenario involving at least one further participant, comprising:
a perception plane configured to aggregate scenario-specific information at a planning timepoint;
a deep learning (“DL”) based processing plane configured to generate a scenario representation of the traffic scenario based on the aggregated scenario-specific information;
a DL-based planning component configured to generate, based on a scenario representation generated by the processing plane, a tree structure consisting of multiple sequences of scenario representations for N>1 consecutive planning time increments i, i∈{0, . . . , N}, such that each subsequent scenario representation generated in a planning time increment i, i∈{1, . . . , N} refers back to and is caused by exactly one parent scenario representation generated in a previous planning time increment i-1; and
at least one predictor component configured to generate at least one one-shot prediction for at least one possible development of the traffic scenario for M>1 consecutive prediction time increments,
wherein the planning component is further configured to condition individual sequences of the tree structure respectively on at least one such one-shot prediction by generating subsequent scenario representations in the individual planning time increments i, i∈{1, . . . , N}, each based on at least one such one-shot prediction.

9. The computer-implemented system according to claim 8, further comprising:
at least one rule-based and/or DL-based first predictor component configured to generate an initial one-shot prediction for M>1 consecutive prediction time increments based on a scenario representation generated by the processing plane.

10. The computer-implemented system according to claim 8, further comprising:
at least one rule-based and/or DL-based second predictor component configured so as to generate at least one current one-shot prediction for each of the parent scenario representations of the individual planning time increments i, i∈{1, . . . , N} for M>1 consecutive prediction time increments.

11. The computer-implemented system according to claim 8, wherein the at least one predictor component is configured to predict a value describing a probability of occurrence for a corresponding development of the traffic scenario for each generated one-shot prediction.

12. The computer-implemented system according to claim 8, wherein the predictor component is configured to determine at least one driving style or a distribution of driving styles for the at least one further participant, such that the planning component is configured to generate different tree structures for different driving styles of the participants.

13. A vehicle comprising:
the computer-implemented system of claim 8 for search-based behavior planning in a given traffic scenario involving at least one further participant.
